(19) United States
(12) Patent Application Publication
(10) Pub. No.: US 2005/0096995 A1
(43) Pub. Date: May 5, 2005

(54) Method for manufacturing, packaging and merchandising light bulbs based on room color

(76) Inventor: Brian Brandes, Brentwood, NY (US)

Correspondence Address: Philip M. Weiss;Weiss & Weiss, 310 Old Country Road, Garden City, NY, 11530, US

(21) Appl. No.: 10/695,851

(22) Filed: Oct. 29, 2003

(51) Int. Cl. G06F 17/60

(52) U.S. Cl. 705/26

(57) ABSTRACT

A method for manufacturing, packaging and merchandising a variety of light bulbs based on room color.

### FIELD OF THE INVENTION

The present invention relates to a method for manufacturing, packaging and merchandising a variety of light bulbs based on room color.

### BACKGROUND OF THE INVENTION

U.S. Pat. No. 6,343,264 relates to color selection method and system for floor, wall, and window coverings. The color selection process includes: (a) the creation of a digital and graphic computer database that classifies a store's or other entity's entire product inventory according to internally harmonious color families, and (b) a visualization experience, using this database, computer graphics and a specially designed color room to give customers a more realistic preview of product(s) being considered. Once customers identify the color family of their home decor, they are able to select floor, window and/or wall coverings with the security that any color chosen from that color family will match their existing interiors.

U.S. Pat. No. 4,331,245 relates to a carpet sample display rack. A rack structure for use in a store for storage and display of samples of material such as of carpet, fabrics, and the like comprises opposite end members positioned in spaced, upright relationship for display of large samples, such as sample books thereon, and a plurality of supportive shelf members extending between and connected to the end members. The shelf members have midportions and front portions and a plurality of spaced divider wall members on each of the shelf members extend from the midportions to the front portions and divide each shelf member into a plurality of narrow, side-by-side trays. Front wall members respectively extend along the front portions to close the front of the trays. A plurality of sample pieces of material of relatively small size are received in the trays and removable therefrom for transport from the store whereby the pieces can be taken to a proposed installation site for examination. In one embodiment, front portions of the shelf members are inclined for viewing of the sample pieces and in another embodiment, the trays include resilient retainers which present the pieces for ease of viewing and removal.

U.S. Pat. No. 4,616,870 relates to a mobile display system. A mobile display system for carpet samples and the like includes a vehicle having an interior space defining a mobile showroom for the carpet samples and the like, a framework having at least one elongated support member, secured to the vehicle within the interior space, and a plurality of racks pivotally mounted in a row on the at least one elongated support member and adapted to hold samples of carpet and the like on both sides thereof. The racks are preferably so closely spaced as to tend to randomly engage one another. The carpet samples and the like cushion the engagement to reduce damage to the racks and noise during vehicle movement without damaging the carpet samples and the like. The structure allows very large numbers of samples to be transported and attractively displayed.

U.S. Pat. No. 5,743,407 relates to a color reference system for decorators. A color reference system for correlating colors to decorating parameters for an area is disclosed. The system includes a color reference card for storage of a color sample and an associated identifier for correlating the color sample to an identifier. Area reference cards for different rooms or locations include decorating parameters such as primary, accent, and accessory color identifiers. When a color sample corresponds to a decorating parameter for a location, its identifier is recorded in association with the decorating parameter. The system may be transported to a decorating or paint store for efficient reference. By looking at a decorating parameter for an area and using the color identifier to find the color sample on the color reference card, a user can quickly find a color sample for comparison purposes without carrying color palettes having color samples which do not correspond to colors in an area to be decorated.

U.S. Patent Application Publication Number U.S. 2003/0076281 relates to diffuse illumination systems and methods. The systems and methods relate to sources of diffuse illumination for providing substantially uniform illumination to a surface. The diffuse illumination arises from varying the diffusion angle of light generated by an LED system. To vary the diffusion angle, a translucent member is placed between the LED system and the surface. Light emitted from the LED system across the translucent member can subsequently uniformly cover the surface. The invention relates to providing light of a selectable color using light sources, such as light emitting diodes. The invention relates to systems and methods for controlling the diffusion angle of light of one or more colors, so as to permit even illumination of a surface.

It is well known that combining the projected light of one color with the projected light of another color will result in the creation of a third color. It is known that red, blue and green can be combined in different proportions to generate almost any color in the visible spectrum. The invention combines the projected light from at least two light emitting diodes of different primary colors.

U.S. Patent Application Publication Number U.S. 2002/0196972 relates to color correction for color devices based on illuminant sensing. A color correction technique involves sensing an illuminant and performing color correction based on the sensed illuminant. A color output device outputs an image with the color correction based on the sensed illuminant. The illuminant may be sensed in the lighting environment where the color output device is located or may be sensed in the lighting environment where the image is captured by a color digital camera. If an illuminant is sensed in a lighting environment where the image is captured and spectral reflectance data for an object corresponding to the image is detected, then the illuminant information and spectral reflectance data are embedded in the image which is transmitted over the Internet to a user computer system. Color correction software of the user computer system extracts the illuminant information and the spectral reflectance data and performs color correction for the image based on the extracted information. The color corrected image corresponding to the illuminant information is displayed or printed.

U.S. Patent Application Publication Number U.S. 2003/0011538 relates to Linear Lighting Apparatus and Method.

Linear lighting systems and methods. In one example, two or more lighting elements having an essentially linear or curvilinear shape are coupled together to form a lighting system. Each lighting element includes a group of LEDs arranged so as to illuminate the essentially linear or curvilinear shape of the lighting element. Each element may include LEDs to generate the same color light, and/or LEDs to generate light of different colors. Additionally, each element may include one or more controllers to control the LEDs so as to create a variety of temporal and/or color-oriented lighting effects. The controller(s) may employ one or more of a variety of control techniques to control the LEDs, such as those involving analog control signals or pulse-width modulated (PWM) control signals. The lighting elements of the system may each be configured as a “stand alone” unit working within the system, producing respective lighting effects that may or may not be coordinated with each other. Alternatively, two or more elements of the system may be configured as addressable lighting elements to facilitate coordination of the elements as a networked lighting system. Any of the foregoing linear lighting systems may be used in a variety of interior or exterior, as well as direct or indirect, lighting applications. In one example, such lighting systems are particularly well-suited as replacements or substitutes for neon lighting installations.

Historically light bulbs (lamps) have always be sold or marketed by application of use. A consumer would purchase a light bulb solely based on what was specified by the lighting fixture manufacturer. No other options existed for the purchaser.

As technology improved a few choices emerged in the fluorescent lamp category. A selection of color temperatures (rated in Kelvins) were made available. Better color rendering products in the fluorescent, HID (High Intensity Discharge) and other lamp types also found their way into the market.

Currently there are many lamp choices available. The majority of the products that are offered in several color temperatures or performance levels tend to be geared to the architectural or commercial segment of the market. These product's features and benefits are explained in technical, industrial terminology and only reference the characteristics of each particular lamp or light source. The selection of lamps in different color temperatures or performance levels has typically been left to an Architect or Lighting Specifier to decide.

### SUMMARY OF THE INVENTION

The present invention relates to manufacturing, packaging and merchandising a variety of light bulbs based on room color.

It is an object of the present invention to adjust the Kelvin rating on numerous light sources. It is an object of the present invention to affect the spectrum of visible light that is emitted. It is an object of the present invention for the light source to enhance the colors that are in the new spectrum that has been created and down play the colors that are not.

It is an object of the present invention to package and market the light bulbs of the present invention based on room color. It is an object of the present invention to create an entirely new and original approach to the sale of light bulbs. It is an object of the present invention to allow a consumer to select a light bulb that works with the color pallet that the user has chosen for their room.

### DETAILED DESCRIPTION OF THE INVENTION

The present invention adjusts the Kelvin rating on numerous light sources. This change in color temperature affects the spectrum of visible light that is emitted. By changing the spectrum, the light source enhances the colors that are in the new spectrum that has been created and down play the colors that are not. For Example, a room that has warm tones of red, orange and brown is embellished by using a lamp in 2700K range. A room that has bright blues and crisp white colors benefits from a lamp in the 4100K level.

By packaging and marketing these products based on room color, the present invention creates an entirely new and original approach to the sale of light bulbs. A consumer can now select a light bulb that will work with the color pallet that they have chosen for their room. In fact, this marketing concept brings light bulbs into the design arena as not only a functional product, but a decorative enhancement.

1. A method of selling light bulbs comprising: manufacturing, packaging and merchandising light bulbs based on room color.

2. The method of claim 1 wherein said light bulbs are manufactured by: adjusting Kelvin rating on light bulbs.

3. The method of claim 1 wherein said light bulbs affect spectrum of visible light that is emitted.

4. The method of claim 3 wherein said light bulbs enhance colors that are in said spectrum that has been created and down plays colors that are not.

5. A method of selling light bulbs comprising:
adjusting a Kelvin rating on said light bulbs;
determining said spectrum of light affected by said light bulb;
packaging said light bulbs;
marking on said packaging how colors in a room are effected by said light bulb.
